(19) United States
(12) Patent Application Publication
(10) Pub. No.: US 2010/0038517 A1
(43) Pub. Date: Feb. 18, 2010

(54) ADJUSTABLE CASTER OF INDOOR COOK STOVE

(76) Inventor: William HOME, Taipei (TW)

Correspondence Address: LEONG C LEI, PMB # 1008, 1867 YGNACIO VALLEY ROAD, WALNUT CREEK, CA, 94598, US

(21) Appl. No.: 12/192,130

(22) Filed: Aug. 15, 2008

(51) Int. Cl. F16M 13/00; F24C 15/08

(52) U.S. Cl. 248/646; 126/304 R

(57) ABSTRACT

An adjustable caster is provided for a cook stove. The caster includes a chassis that is mounted to a bottom of the stove. A curved frame is rotatably mounted to the chassis and has opposite ends to which a roller, which is engageable with ground, and an operation sleeve are respectively and rotatably mounted. An adjustment nut seat is pivoted to the chassis and forms a bore to which a nut is mounted in an aligned manner. A bolt engages with and extends through the nut to have an end thereof engaging and abutting an end of the operation sleeve, whereby rotation of the bolt with respect to the nut seat applies a pushing force to the rotation sleeve, which in turn causes the curved frame to rotate, bringing the roller into engagement with the ground and further adjusting the distance between the ground and the stove bottom.

### BACKGROUND OF THE INVENTION

(a) Technical Field of the Invention

The present invention relates to an adjustable caster for an indoor cook stove, and in particular to an adjustable caster that is mounted to a corner of the bottom of the cook stove and uses horizontal rotation of an adjustment bolt to drive a curved frame that carries a roller so as to carry out adjustment of distance of the stove bottom with respect to the ground and thus improving the difficult operation of rotating a vertical bolt of the conventional leveling foot.

(b) Description of the Prior Art

Counters or furniture that is arranged indoor is often provided with leveling feet on a bottom thereof to adjust the distance between the bottom and ground on which the counters or the furniture is positioned. The leveling foot comprises a vertically arranged bolts, working with an internally threaded member that is positioned in the proximity of a corner of the bottom to adjust the distance of the bottom corner from the ground and also adjust leveling of four corners of the bottom by relative rotation between the bolt and the internally threaded member. For counters or furniture that is not very heavy, the adjustment can be easily done by rotating the leveling foot to elevate or lower the respective corner with respect to the ground, whereby leveling of the four corners can be easily achieved. (Since the ground surface on which the counters or the furniture is positioned may not be irregular, all the four corners or more locations of the counter or furniture must be simultaneously adjusted to set the leveling in order to cope with the irregularity of the ground surface.) However, for a piece of furniture that is very heavy, the weight of the furniture applies a great load to the engaging threading face of the bolt, leading to substantial increase of the friction force acting thereon, thereby making the adjustment very effort consuming.

Further, an indoor cook stove is often heavier than a regular counter or table and this is particularly true for modern cook stoves, for to ease cleaning and wiping operation, a modern cook stove is often composed of a large amount of stainless steel, including stove top and other parts, and the stainless steel parts substantially increase the overall weight of the cook stove. The conventional leveling foot no longer performs easy adjustment of the distance of the furniture from the ground and the leveling of four corners. Apparently, new mechanisms that allow easy adjustment of the distance from the ground and four corner leveling are needed for a cook stove.

Thus, the present invention is aimed to overcome such a drawback that the conventional leveling foot is not sufficiently effortless in adjusting a distance from ground and four corner leveling of a cook stove by providing an adjustable caster for the cook stove.

### SUMMARY OF THE INVENTION

The primary purpose of the present invention is to provides an adjustable caster for an indoor cook stove. The adjustable caster is provided for being respectively mounted to four corners of a bottom of the indoor cook and includes an adjustment bolt that is arranged in such a way to allow horizontal rotation thereof for driving movement of a curved frame that carries a roller to carry out adjustment of the altitude of the stove bottom with respect to the ground and the leveling thereof, whereby by means of causing the curved frame to stretch to and abut the ground, the drawback that the vertical rotation of bolt to adjust the altitude of the conventional cook stove is hard to perform can be overcome and the adjustment of the altitude of the indoor cook stove with respect to the ground and the leveling among four corners of the cook stove can be easily performed. This is the primary objective of the present invention.

The adjustable caster for an indoor cook stove in accordance with the present invention further comprises a ground-contact roller that is pivotally mounted to an end of the curved frame that threads on the ground. By keeping the ground-contact rollers in contact with the ground, maneuverability realized by sliding can be enhanced. This is helpful in house cleaning, in which the space that is originally occupied by the cook stove can be emptied to help cleaning and once the cleaning is done, the cook stove can be easily moved back. This is another objective of the present invention.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an adjustable caster that is constructed in accordance with the present invention for an indoor cook stove;

FIG. 2 is an exploded view of the adjustable caster of the present invention;

FIG. 3 is a cross-sectional view of the adjustable caster of the present invention;

FIG. 4 illustrates the operation of the adjustable caster of the present invention; and

FIG. 5 illustrates an application of the adjustable caster of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

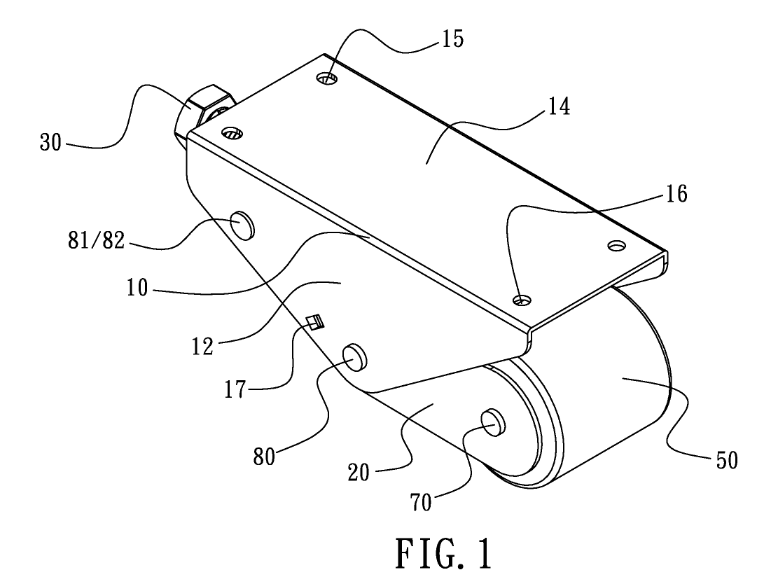

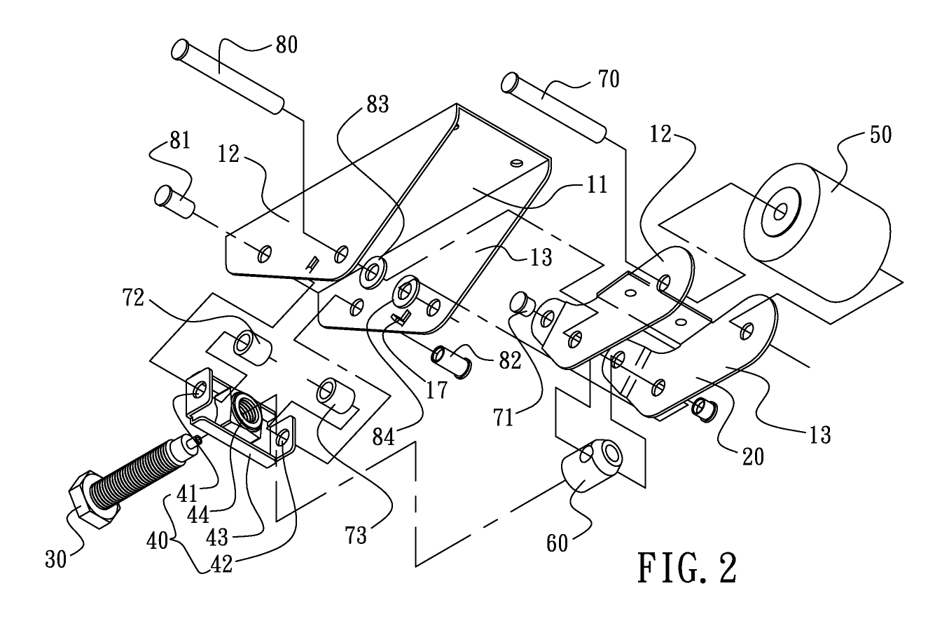

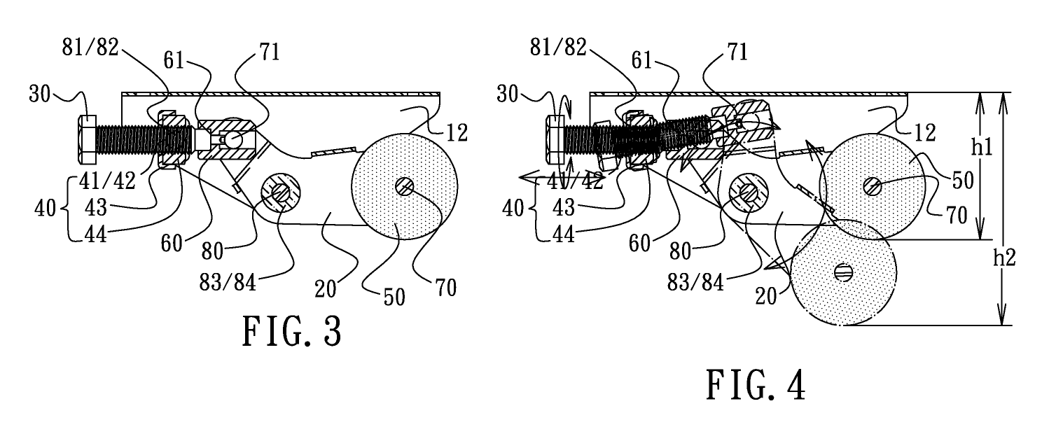

With reference to the drawings and in particular to FIGS. 1-3, wherein FIG. 1 is a perspective view of an adjustable caster that is constructed in accordance with the present invention for a cook stove, FIG. 2 is an exploded view of the adjustable caster of the present invention, and FIG. 3 is a cross-sectional view of the adjustable caster of the present invention, the adjustable caster in accordance with the present invention comprises a caster retention chassis 10 that forms a roller compartment 11 that is open toward ground to receive therein at least one curved frame 20, an adjustment bolt 30, an adjustment nut seat 40, a ground-contact roller 50, an operation sleeve 60, a first moving-portion shaft 70, a second moving-portion shaft 71, a first fixed-portion shaft 80, and aligned and opposite second fixed-portion shafts 81, 82. The curved frame 20 has an end threading on ground with the first moving-portion shaft 70 extending therethrough to fit through the ground-contact roller 50 and an opposite end that is curved away from ground with the second moving-portion shaft 71 extending therethrough to couple the operation sleeve 60. The first fixed-portion shaft 80 is arranged to extend through opposite side walls 12, 13 that delimit the roller compartment 11 and a central portion of a bending section of the curved frame 20. The aligned and opposite second fixed-portion shafts 81, 82 are arranged to respectively and oppositely extend through the side walls 12, 13 that delimit the roller compartment 11 at locations of the side walls 12, 13 that delimit the roller compartment 11 corresponding to sides of a drive end of the operation sleeve 60 to fit into and clamp therebetween shaft coupling holes 41, 42 defined in opposite side portions of the adjustment nut seat 40. The adjustment bolt 30 is set to extend through the adjustment nut seat 40 to fit into the drive end 61 of the operation sleeve.

Collars 72, 73 are respectively fit over portions of the second moving-portion shaft 71 that respectively correspond to the end of the curved frame 20 that is curved away from ground and are located inward of the respective shaft coupling holes 41, 42 of the adjustment nut seat 40 and washers 83, 84 are respectively fit over portions of the first fixed-portion shaft 80 between the central portion of the bending section of the curved frame 20 and the two side walls 12, 13 that delimit the roller compartment 11, whereby sideway shifting and shaking of the central portion of the bending section of the curved frame 20 is eliminated and friction area at the rotating portion is reduced. Further, a plurality of through holes 15, 16 is defined in a top board 14 of the caster retention chassis 10 to facilitate bolting of the whole device to a mounting position. Further, the adjustment nut seat 40 can be formed by a nut 44, which is threadingly engageable with the adjustment bolt 30, fixed by welding to a central portion of a seat board 43 that forms a bore in the central portion thereof for the extension of the adjustment bolt 30 and has the opposite side portions respectively forming perpendicularly bent walls that form therein the shaft coupling holes 41, 42. Further, the two side walls 12, 13 that delimit the roller compartment 11 respectively form perpendicularly bent and inward extending stop blocks 17 at locations corresponding to the central portion of the bending section of the curved frame 20, whereby when the curved frame 20 is rotated in a direction into the roller compartment 11 to a dead point, the curved frame 20 is stopped and constrained by the stop blocks 17.

The adjustment operation is illustrating by FIG. 4, in which the device is shown in a condition of completely floating off and thus not in contact with the ground, as shown, the adjustment bolt 30 can be easily rotated inward and/or outward (with a tool corresponding to a head of the adjustment bolt) to thereby drive and push the operation sleeve 60 for rotating the end of the curved frame 20 that is away from ground, and at the same time, the adjustment nut seat 40 responds to the variation of the pushing length of the adjustment bolt 30 to automatically rotate for correction, making the curved frame 20 subjected to the pushing operation to change the distance of a ground-contact point of the ground-contact roller 50 with respect to the top board 14 as illustrating by the change from distance h1 to distance h2 or from distance h2 to the distance h1. Due to this, together with the reason that a relative motion causes positions to change correspondingly, once the ground-contact roller 50 is subjected to a load to engage the ground and maintains at a fixed level, the adjustment of the distance will be completely reflected on the position of the top board 14.

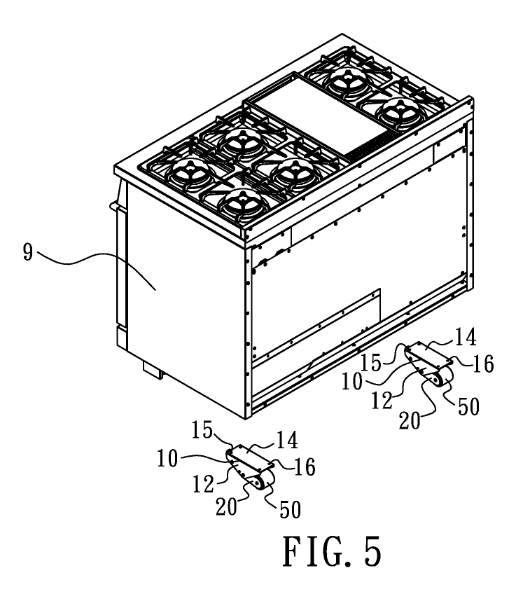

As such, as illustrated in an application shown in FIG. 5, with the adjustable caster of the present invention mounted to each of four corners of the bottom of an indoor cook stove 9, the off-ground distance and leveling of the bottom of the cook stove can be easily adjusted and the drawback of being difficult to adjust the vertical height occurring in the conventional leveling foot that is realized by direct rotation of bolt can thus be improved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An adjustable caster for a cook stove that has a bottom to which the adjustable caster is mounted, the adjustable caster being characterized by comprising a caster retention chassis forming a roller compartment open toward ground to receive therein at least one curved frame, an adjustment bolt, an adjustment nut seat, a ground-contact roller, an operation sleeve, a first moving-portion shaft, a second moving-portion shaft, a first fixed-portion shaft, and aligned and opposite second fixed-portion shafts, wherein the curved frame has an end threading on ground with the first moving-portion shaft extending therethrough to fit through the ground-contact roller and an opposite end that is curved away from ground with the second moving-portion shaft extending therethrough to coupled the operation sleeve, the first fixed-portion shaft being arranged to extend through opposite side walls that delimit the roller compartment and a central portion of a bending section of the curved frame, the aligned and opposite second fixed-portion shafts being arranged to respectively and oppositely extend through the side walls that delimit the roller compartment at locations of the side walls that delimit the roller compartment corresponding to sides of a drive end of the operation sleeve to fit into and clamp therebetween shaft coupling holes defined in opposite side portions of the adjustment nut seat, the adjustment bolt extending through the adjustment nut seat to fit into the drive end of the operation sleeve.

2. The adjustable caster as claimed in claim 1 further comprising collars respectively fit over portions of the second moving-portion shaft that respectively correspond to the end of the curved frame that is curved away from ground and are located inward of the respective shaft coupling holes of the adjustment nut seat.

3. The adjustable caster as claimed in claim 1 further comprising washers respectively fit over portions of the first fixed-portion shaft between the central portion of the bending section of the curved frame and the two side walls that delimit the roller compartment.

4. The adjustable caster as claimed in claim 2 further comprising washers respectively fit over portions of the first fixed-portion shaft between the central portion of the bending section of the curved frame and the two side walls that delimit the roller compartment.

5. The adjustable caster as claimed in claim 1, wherein the adjustment nut seat is formed by a nut, which is threadingly engageable with the adjustment bolt, fixed to a central portion of a seat board that forms a bore in the central portion thereof for extension of the adjustment bolt and has the opposite side portions respectively forming perpendicularly bent shaft coupling hole walls.

6. The adjustable caster as claimed in claim 1, wherein the two side walls that delimit the roller compartment respectively form perpendicularly bent and inward extending stop blocks at locations corresponding to the central portion of the bending section of the curved frame, whereby when the curved frame is rotated in a direction into the roller compartment to a dead point, the curved frame is stopped and constrained by the stop blocks.
